(19) United States
(12) Patent Application Publication
(10) Pub. No.: US 2026/0123790 A1
(43) Pub. Date: May 7, 2026

(54) CLAMSHELL GRILL, PLATEN ASSEMBLY, AND METHODS FOR THE USE THEREOF

(71) Applicant: Middleby Marshall Inc., Elgin, IL (US)

(72) Inventors: Jason Lyle Sands, Fuquay-Varina, NC (US); Jason David Schreiner, Angier, NC (US); William Elbert Means, II, Fuquay-Varina, NC (US); Brian Anthony Murton, Clayton, NC (US)

(73) Assignee: Middleby Marshall Inc., Elgin, IL (US)

(21) Appl. No.: 19/379,947

(22) Filed: Nov. 5, 2025

Related U.S. Application Data
(60) Provisional application No. 63/716,955, filed on Nov. 6, 2024.

(51) Int. Cl. A47J 37/06; A23L 5/10; A47J 36/12

(52) U.S. Cl. CPC A47J 37/0611; A23L 5/11; A47J 36/12

(57) ABSTRACT

A clamshell grill includes a griddle plate defining a cooking surface and a platen having a sealing member defining a perimeter of an interior cooking cavity. The platen is moveable between a non-cooking position, wherein the sealing member is spaced apart from the cooking surface, and a cooking position, wherein the sealing member is engaged with the cooking surface and defines an enclosed cooking volume. A fluid source may be coupled to the platen and includes an outlet in fluid communication with the enclosed cooking volume, at least when the platen is moved to the cooking position. A platen assembly and methods for the use and assembly of the clamshell grill are also provided.

### CROSS-REFERENCE TO RELATED APPLICATIONS

This application claims priority from U.S. Provisional Application No. 63/716,955, filed November 6, 2024, which is hereby fully incorporated by reference herein in its entirety.

### FIELD OF THE INVENTION

The present application relates generally to a clamshell grill, and in particular to a clamshell grill having a platen assembly, to the platen assembly, and to methods for the use and assembly thereof.

### BACKGROUND

Clamshell grills often include upper and lower heating plates, which may be moved toward or away from each other. The heating plates apply heat to opposite sides of a food product, which may decrease the cooking time for the food product while cooking the food product more evenly. Such systems typically do not create a seal around the food product to trap the heat surrounding the food product, and also do not provide for the introduction of any liquid, such as water, to maintain the moisture in the product.

### SUMMARY

The present invention is defined by the following claims, and nothing in this section should be considered to be a limitation on those claims.

In one aspect, one embodiment of a clamshell grill includes a griddle plate defining a cooking surface and a platen having a compressible seal defining a perimeter of an interior cooking cavity. The platen is moveable between a non-cooking position, wherein the seal is spaced apart from the cooking surface, and a cooking position, wherein the seal is engaged with the cooking surface and defines an enclosed cooking volume. A fluid source is coupled to the platen and includes an outlet in fluid communication with the enclosed cooking volume at least when the platen is moved to the cooking position.

In another aspect, one embodiment of a platen assembly configured for use with a griddle plate includes a housing and a platen moveably coupled to the housing, wherein the platen is moveable between a non-cooking position and a cooking position. The platen includes a plate defining a cooking surface and a compressible seal extending from the cooking surface, wherein the seal defines a perimeter of an interior cooking cavity. A fluid source is coupled to the platen and includes an outlet in fluid communication with the interior cooking cavity at least when the platen is moved to the cooking position.

In another aspect, one embodiment of a clamshell grill includes a griddle plate defining a cooking surface and a platen moveable relative to the cooking surface from a non-cooking position to a cooking position. A panel is moveably connected to the platen. The panel is engageable with the cooking surface and moveable relative to the platen as the platen is moved between the non-cooking position and the cooking position. The panel defines at least in part an enclosed cooking volume when engaged with the cooking surface. In various embodiments, a pair of side panels, front panel and/or rear panel may be moveably connected to the platen. The side panels, front panel and/or rear panel may be integrally formed as a single sealing housing moveably connected to the platen, or may be independently connected to the platen.

In another aspect, a clamshell grill includes a griddle plate defining a lower cooking surface and a platen having an upper cooking surface. A sealing member is coupled to the platen and includes a sealing edge. The platen is moveable between a non-cooking position, wherein the sealing edge is spaced apart from the cooking surface, and a cooking position, wherein the sealing edge is engaged with the cooking surface and defines an enclosed cooking volume. The sealing edge is moveable relative to the upper cooking surface as the platen is moved between the non-cooking and cooking positions. In various embodiments, the sealing member may be configured as a moveable panel or a compressible seal.

In yet another aspect, one embodiment of a method of cooking a food product includes depositing the food product on a cooking surface of a griddle plate, moving a platen having a compressible seal defining a perimeter of an interior cooking cavity from a non-cooking position, wherein the seal is spaced apart from the cooking surface, to a cooking position, wherein the seal is engaged with the cooking surface and defines an enclosed cooking volume, and introducing a fluid into the enclosed cooking volume from a fluid source coupled to the platen.

The various embodiments of the clamshell grill, platen assembly and methods provide significant advantages over other clam shell grills, and methods for the assembly and use thereof. For example, and without limitation, the sealing member creates an enclosed cooking volume that traps heat to more quickly and evenly cook the food product. The sealing member may be compressible, which provides for different height cooking volumes that may accommodate food products of varying sides. The system further allows for the introduction of a fluid into the cavity, which can further improve the cooking of the food product while maintaining the moisture in the food product. The platen assembly may be removably installed on the grill, which provides a single surface griddle. The system and method of use is simple, with the fluid being introduced by gravity from a reservoir in one embodiment. The system is easily cleaned and suitable for a variety of food products.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a clamshell grill.

FIG. 2 is a front view of the clam shell grill shown in FIG. 1.

FIG. 3 is a cross-sectional perspective view of the clamshell grill taken along line 3-3 in FIG. 1.

FIG. 4 is a front view of the clamshell grill shown in FIG. 3.

FIG. 5 cross-sectional view of one embodiment of the clam shell grill taken along line 5-5 in FIG. 1.

FIG. 6 is enlarged, partial view of the clamshell grill taken along line 6 in FIG. 5.

FIG. 7 cross-sectional view of another embodiment of the clam shell grill taken along line 7-7 in FIG. 1.

FIG. 8 is enlarged, partial view of the clamshell grill taken along line 8 in FIG. 7.

FIG. 9 is front perspective view of a clam shell grill with the platen and panels in a cooking position.

FIG. 10 is a right side, front perspective view of the clam shell grill shown in FIG. 9 with the platen and panels in a non-cooking position.

FIG. 11 is a front view of a clam shell grill shown in FIG. 10 with the platen and panels in a non-cooking position.

FIG. 12 is a left side, front perspective view of a clam shell grill with the platen and panels in a non-cooking position.

FIG. 13 is a perspective view of one embodiment of a sealing housing.

FIG. 14 is a front view of another embodiment of a clam shell grill.

FIG. 15 is a perspective view of the clam shell grill shown in FIG. 14.

FIG. 16 is a cross-sectional view of the clam shell grill shown in FIG. 14.

FIG. 17 is a partial perspective view of the clam shell grill shown in FIG. 14.

FIG. 18 is another cross-sectional view of the clam shell grill shown in FIG. 14, having a first embodiment of a release mechanism in a locked state.

FIG. 18A is an enlarged, partial, cross-sectional view of the release mechanism shown in FIG. 18 in a released state.

FIG. 19 is another cross-sectional view of the clam shell grill shown in FIG. 14, having a second embodiment of a release mechanism in a locked state.

FIG. 19A is an enlarged, partial, cross-sectional view of the release mechanism shown in FIG. 19 in a released state.

### DETAILED DESCRIPTION OF THE PRESENTLY PREFERRED EMBODIMENTS

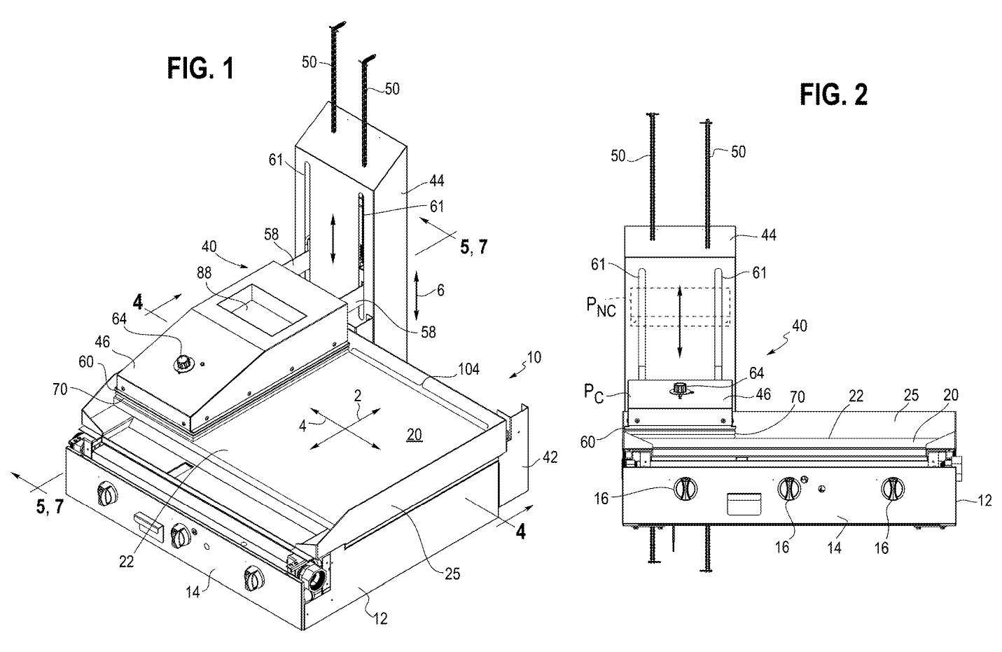

It should be understood that the term "plurality," as used herein, means two or more. As shown in FIGS. 1-4, the term "longitudinal," as used herein, means of or relating to a length or lengthwise direction 2, 6, for example the flow front-to-back direction 2 of a clamshell grill 10, or a vertical direction 6 of a lift mechanism. The phrase “clamshell grill” refers to a cooking system having a pair of spaced apart cooking surfaces that may be applied to a food product. The term "lateral," as used herein, means situated on, directed toward or running in a transverse or side-to-side direction 4. The term “coupled” means connected to or engaged with whether directly or indirectly, for example with an intervening member, and does not require the engagement to be fixed or permanent, although it may be fixed or permanent. The terms “first,” “second,” and so on, as used herein, are not meant to be assigned to a particular component or feature so designated, but rather are simply referring to such components and features in the numerical order as addressed, meaning that a component or feature designated as “first” may later be a “second” such component or feature, depending on the order in which it is referred. It should also be understood that designation of “first” and “second” does not necessarily mean that the two components, features or values so designated are different, meaning for example a first direction may be the same as a second direction, with each simply being applicable to different components or features. The terms “upper,” “lower,” “rear,” “front,” “fore,” “aft,” “vertical,” “horizontal,” and variations or derivatives thereof, refer to the orientations of the exemplary grill as shown in FIGS. 1-4.

The various embodiments of the clamshell grill 10, and components thereof, provide significant advantages over other clamshell grills. The preferred embodiments accomplish this by new and novel arrangements of elements, materials, relationships, and methods that are configured in unique and novel ways, and which demonstrate previously unavailable but preferred and desirable capabilities. The description set forth below in connection with the drawings is intended merely as a description of the presently preferred embodiments of the invention, and is not intended to represent the only form in which the present invention may be constructed or utilized. The description sets forth the designs, materials, functions, means, and methods of implementing the invention in connection with the illustrated embodiments. It is to be understood, however, that the same or equivalent functions, features, and material properties may be accomplished by different embodiments that are also intended to be encompassed within the spirit and scope of the invention. The present disclosure is described with reference to the accompanying drawings with preferred embodiments illustrated and described. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout the disclosure and the drawings. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

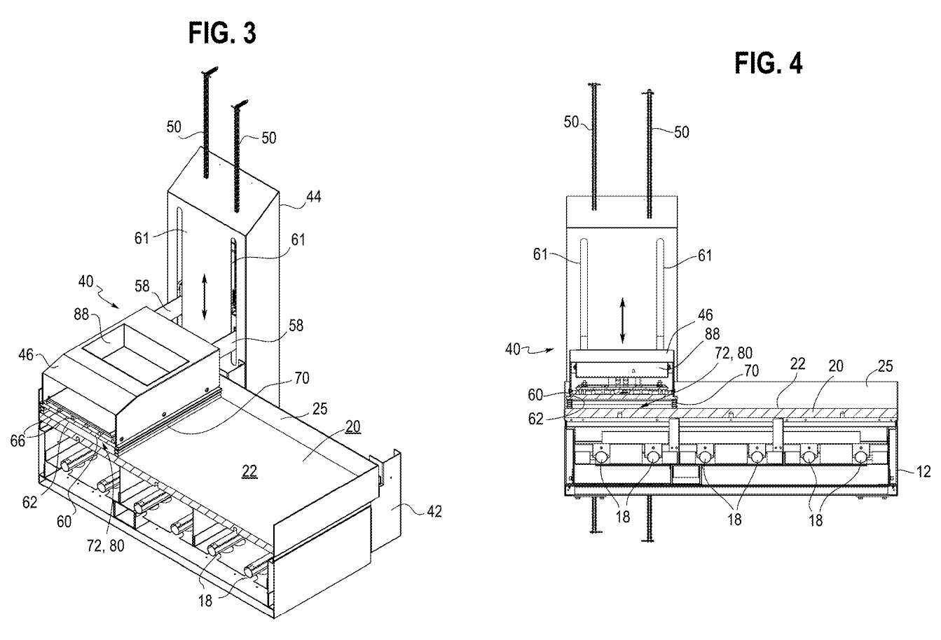

As shown in FIGS. 1 & 2, the clamshell grill 10 includes a housing 12 having a front control panel 14 with a plurality of temperature setting controls 16, shown as knobs. As shown in FIGS. 3 and 4, a plurality of heating elements 18 is disposed in a base of the housing. A griddle plate 20, otherwise referred to as a lower platen, is supported by the housing 12 over the heating elements 18. The heating elements may be electric or gas. When actuated by the control(s) 16, the heating elements 18 heat the griddle plate 20, which defines an upper cooking surface 22. A food product 24 may be positioned on the cooking surface 22, as shown for example in FIG. 6. A splash/spill guard 25 is coupled to the housing 12 and extends upwardly along a rear and side edges of the griddle plate 20 in order to contain fluid, such as oil or grease, applied and/or produced during a cooking event.

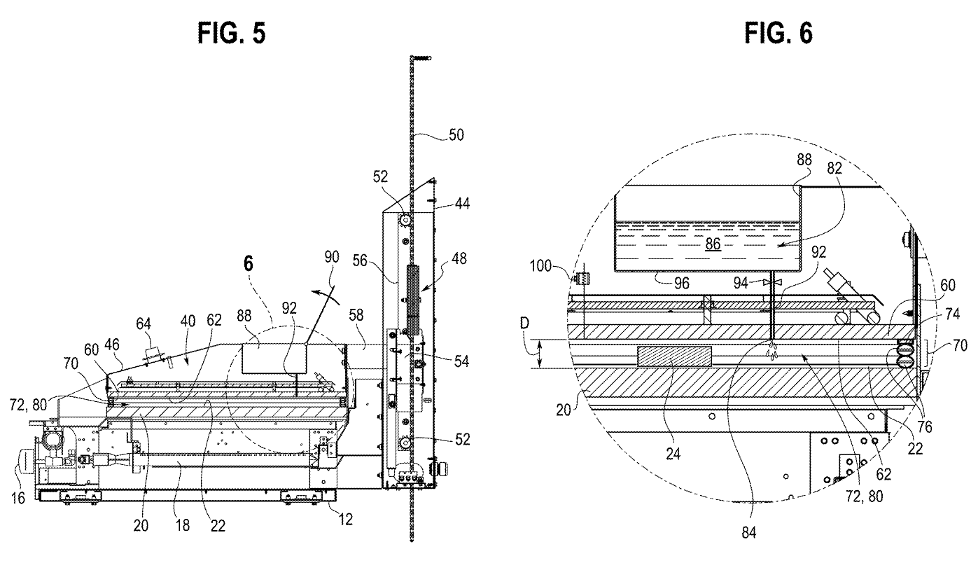

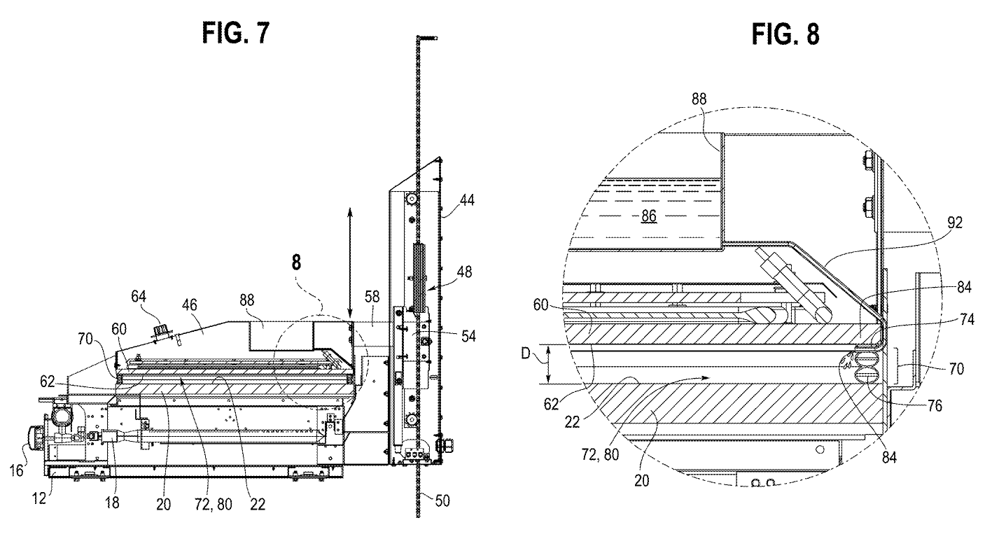

Referring to FIGS. 1-5 and 7, a platen assembly 40 may be secured to a rear of the housing, for example with one or more brackets 42. The platen assembly includes a lift housing 44 and a platen housing 46. A lift mechanism 48 is disposed in the lift housing 44 and includes a pair of drive chains 50 (shown vertically in an unconnected configuration). As shown in FIG. 5, the drive chains 50 wrap around a pair of vertically spaced gears 52. A carriage 54 is coupled to the chains and rides along a track or guide 56 defined interiorly of the housing. The platen housing 46 is coupled to the carriage 54 with a pair of arms 58, which extend through a pair of laterally spaced and longitudinally extending slots 61 formed in the front face of the lift housing 44. The carriage 54 and platen housing 46 may be manually raised and lowered, for example with the assistance of a counterweight and/or springs. In other embodiments, the carriage and platen housing may be raised and lowered by a motor engaged with gears and/or chain, with the motor actuated by an actuator engaged by an operator.

The platen housing 46 supports a platen 60, or upper plate, having a lower surface 62 facing the cooking surface 22. The platen 60 may have an exemplary width including and between 8 and 36 inches, although other widths may be suitable. The platen 60 may be heatable, and may be actuated by a temperature setting control 64 accessible on top of the housing. One or more heating elements 66 are disposed in the platen housing above the platen 60. The heating elements may be electric or gas. When actuated by the control 64, the heating elements 66 heat the platen, or an upper plate 60, which may engage the food product 24 sandwiched between the lower surface 62 of the upper plate 60 and the lower cooking surface 22, as shown for example in FIG. 6.

A compressible seal 70 defining a perimeter of an interior cooking cavity is connected to the lower surface 62 of the platen 60, or alternatively to the housing 46. The seal 70 may extend around the perimeter, or periphery, of the platen 60, and defines a closed ring in one embodiment. The closed ring may define an interior cooking cavity 72. The seal 70 may include a base portion 74 coupled to the platen 60, for example integrally or with adhesive and/or mechanical fasteners. The seal 70 may further include compressible member(s) 76, for example defined as one or more compressible tubes. The compressible member(s) may be made of high temperature silicon. For example, as shown in FIGS. 6 and 8, the seal 70 is configured with a pair of vertically stacked compressible tubes 76. The seal may include more or less tubes, for example between 1 and 4 tubes, which may be ½ inches in diameter for example and without limitation. The seal may also be configured with bellows, or other flexible and compressible seals.

As shown in FIG. 1, the platen 60 is moveable between a non-cooking position (P_{NC}), wherein the seal 70, and in particular a sealing edge/surface thereof, is spaced apart from the cooking surface 22, and a cooking position (P_{C}), wherein the seal 70, and in particular a sealing surface/edge of at least a lowermost compressible member 76, is engaged with the cooking surface 22 and defines an enclosed cooking volume 80 with the cooking surface 22 and the lower surface 62 of the platen 60. The sealing surface/edge of the seal 70, when engaged with the cooking surface 22, moves relative to the platen (upper plate) 60 as the platen or upper plate is moved/lowered to the cooking position. It should be understood that the phrase “enclosed cooking volume” is not limited to a fully enclosed volume that is sealed off from the ambient, or surrounding environment. For example, the system may have one or more breaks in the seal 70, or openings, to allow for example venting. Or the volume is at least partially closed off, for example on at least three sides. At the same time, in other embodiments, the “enclosed cooking volume” may include a fully sealed volume.

The seal 70, and in particular the compressible member(s) 76, is compressible down to 1/8 inch. In this way, the seal 70 maintains a seal with the cooking surface 22 over a predetermined range of distances (D) measured between the cooking surface 22 and the lower surface 62 of the upper platen 60. The minimum compressed thickness (fully compressed thickness) of the seal 70 = T (e.g., 1/8 inch), with the compressibility = t, such that D = T+t. If t=0, then D=T, which is the minimum space D. In various embodiments, D is between and including 1/8 inch and 4 inches.

A fluid source 82 may be coupled to the platen 60, for example by way of the housing 46, and includes an outlet 84 in fluid communication with the enclosed cooking volume 80 at least when the platen 60 is moved to the cooking position (P_{C}). The fluid source 82 may include a liquid source 86 and/or steam source. In one embodiment, shown in FIGS. 1-8, the liquid source 86 is configured as a gravity-fed fluid source, which is held in a fluid reservoir 88. The liquid source may be water, or another liquid such as oil. The reservoir 88 may be formed in, or supported by, the housing 46, and may be open to a top thereof such that it may be filled with the liquid 86, as shown in FIG. 6. A cover 90 may be disposed over the top of the reservoir 88 to keep the liquid from spilling. A conduit 92 is in fluid communication with a bottom 96 of the reservoir 88. An end portion of the conduit 92 defines the outlet 84. As shown in FIG. 6, the conduit 92 may extend through the platen 60, or be formed in the upper plate. In an alternative embodiment, shown in FIG. 8, the conduit 92 passes around an edge of the platen 60 and extends through the base portion 74 of the seal 70. In either embodiment, the outlet 84 is positioned adjacent the surface 62 of the platen 60, such that the conduit 92 does not interfere with the food product 24 during the cooking sequence.

As shown in FIGS. 6 and 8, the liquid 86 may flow from the reservoir 88 through the conduit 92 and exit the outlet 84 into the interior cooking volume 80 and onto the cooking surface 22, wherein the liquid may be vaporized in some embodiments, or may collect on the cooking surface, depending on the temperature of the heated surfaces 22, 62 and interior volume 80. A valve 94 may be positioned to control the flow through the conduit 92, and may be actuated to close or open the conduit 92. In various embodiments, the valve may be manually controlled to drip or may be configured as an electro-mechanical valve that opens/closes to release a specified amount of water. In other embodiments, the fluid source may be a pressurized fluid source, which may be coupled to the platen housing, directly or indirectly, for example by a releasable coupling. The pressurized fluid source may include a pump or compressor. In one embodiment, the fluid may be a steam introduced into the interior volume 80 through the outlet 84. In one embodiment, a pressure relief valve 100 may be in fluid communication with the interior volume and the ambient environment. The valve 100 may open to relieve the pressure of the interior volume 80 when the pressure exceeds a predetermined value.

The lift mechanism 48 moves the platen 60 between the non-cooking position (P_{NC}) and the cooking position (P_{C}). An operator may apply a force to the platen 60, for example with a handle 310, to apply a pressure between the seal 70 and the cooking surface 22, and the weight of the platen 60 itself applies pressure and seals the platen with the cooking surface. As shown in FIGS. 1-4, the lift mechanism 48 is configured to translate the platen 60 as the platen is moved between the cooking and non-cooking positions. In this embodiment, the platen is maintained in a horizontal, parallel orientation throughout the movement path, such that liquid 86 in the reservoir 88 is not spilled or otherwise displaced. The lift mechanism 48 may alternatively be configured to pivot the platen, or both pivot and translate the platen.

As shown in FIGS. 1-4, the platen 60 may only cover a portion of the upper cooking surface 22 of the griddle plate 20 such that an uncovered portion 104 may be simultaneously used for cooking food products not requiring two-sided cooking or supplemental fluid cooking environments provided by the platen. In some embodiments, the platen 60, in combination with the seal 70, may be used to enclose the food product 24 in the interior volume 80 without the introduction of liquid 86 through the outlet 84, for example when the valve 94 is closed and/or the reservoir 88 is empty.

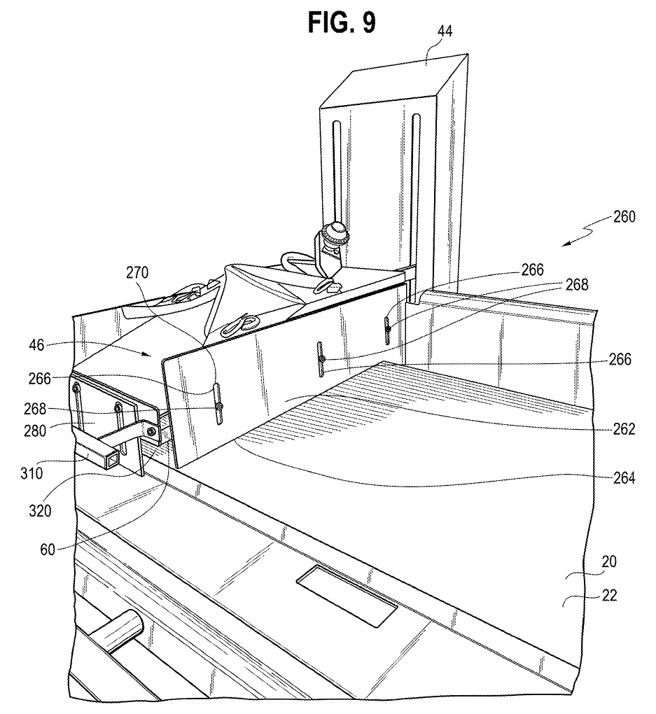

Referring to FIGS. 9-13, alternative embodiments of a platen assembly 260 are configured with a pair of side panels 262 moveably attached to the platen assembly 260, for example the housing 46. The side panels 262, or seal members, may be made for example of stainless steel, or any other suitable material. In one embodiment, the side panels are rigid and do not compress. The side panels 262 may be moveably coupled to the housing 46. The side panels 262 are moveable relative to the platen 60 as a lower sealing edge 264 of the side panels 262 engages the cooking surface 22 and the platen 60 is moved between the cooking position and the non-cooking position. The side panels 262 may be used in combination with the seal 70, or the seal 70 may be omitted. The side panels 262 are moveable coupled to the platen housing 46 with one or more pins or shafts 268 extending outwardly from the platen housing 46. The shafts 268 are disposed in a corresponding number of elongated vertical slots 266. The side panels 262 move relative to the platen 60 as the shafts 268 slide in the slots 266. It should be understood that the slots may be formed in the platen housing and the shafts extend from the panel 262. The length of the slots 266 defines the range of distances D between the platen 60 and the cooking surface 22, with the maximum D defined when the shafts engage the top 270 of the slots. The side panels may be moveably attached to the platen assembly with other systems and mechanisms, including for example and without limitation tracks and rollers, scissor mechanisms, gears/transmissions and other interface systems.

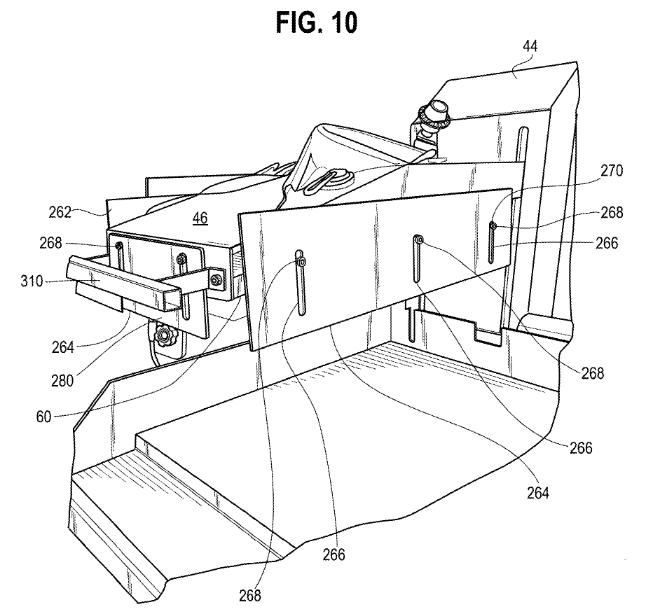

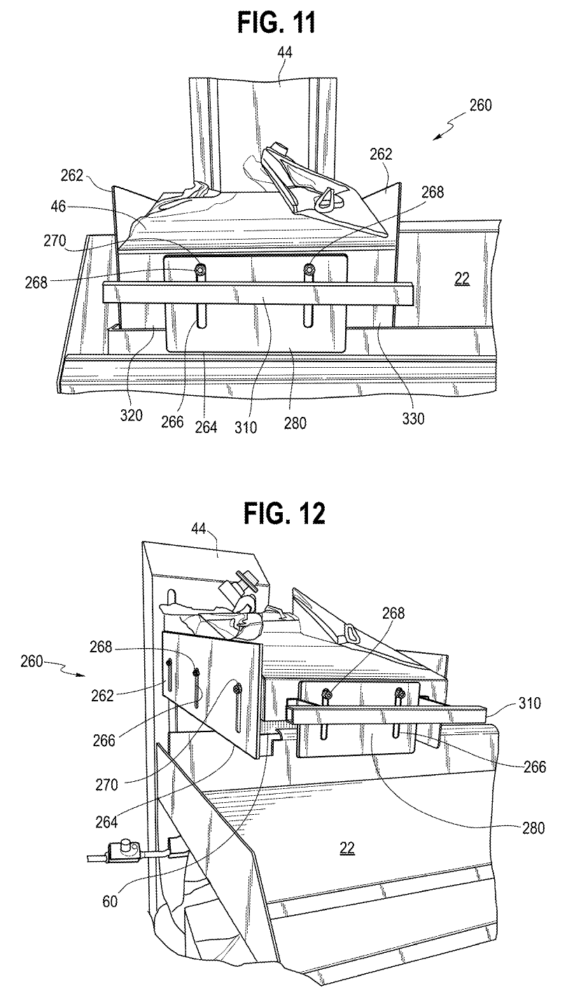

In a non-cooking position, shown in FIG. 10, the shafts 268 engage the top end 270 of the slot and lift the side panels 262 away from the cooking surface 22. As the platen 60 is lowered to a cooking position, the lower sealing edge 264 of the side panels 262 engage the cooking surface 22, causing the platen 60 to move relative to the side panels 262, and sealing edges 264, as the platen is moved to its final cooking position. The shafts 268 move in the slots 266 as the platen 60 is lowered relative to the side panels 262. The sealing edges 264 of the side panels 262 seal against the cooking surface 22 and define in part the enclosed cooking volume 320, together with the platen surface 62 and the cooking surface 22. In this embodiment, the enclosed cooking volume may be open along portions of the front of the platen if the platen is not configured with a seal 70. A front panel 280 may also be configured with slots 266 sliding along shafts 268 extending from the front of the platen. The front panel 280 may not extend along the entirety of the platen, as shown for example in FIG. 11, such that openings 330 are formed between the cavity and the ambient.

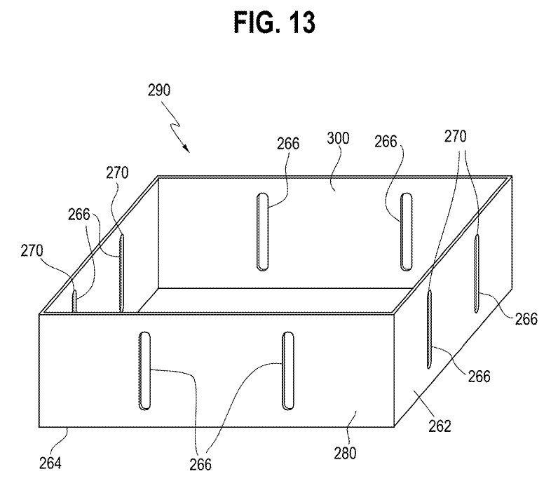

In one embodiment, show in FIG. 13, the side panels and/or front panel are integrally formed as part of a housing 290 that also includes the side panels 262, the front panel 280 and a back panel 300, with the housing defining a wrap that that may move relative to the platen 60 so as to define different cooking volumes, or distance D defined between the platen and the cooking surface. In other embodiments, the sealing system may include only one end panel 280, 300 and two side panels 262, or two end panels 280, 300 and no side panels. The side panels 262 and end panels 280, 300 may be connected to integrally form a single housing 290, or may be independently connected to and adjusted relative to the platen 260, for example as shown in FIGS. 9-12.

In operation, one method of cooking the food product 24 includes depositing the food product 24 on the cooking surface 22 of the griddle plate 20, moving the platen 60 having the compressible seal 70 defining a perimeter of the interior cooking cavity 72 from the non-cooking position, wherein the seal 70 is spaced apart from and not in contact with the cooking surface 22, to the cooking position, wherein the seal 70 is engaged with the cooking surface 22 and defines the enclosed cooking volume 80, and introducing the liquid 86 into the enclosed cooking volume from a fluid source coupled to the platen 60. In one embodiment, the reservoir 88 may be filled with the fluid, which passes through the conduit 92 and outlet 84 by the force of gravity. The valve 94 may be manipulated to close or open the conduit. In other embodiments, the fluid may be a pressurized fluid, such as steam. The cooking surface 22, and/or the lower surface 62 of the platen may be heated before and during the cooking operation. The fluid introduced into the interior volume 80 from the outlet 84 may be a liquid that is vaporized and produces steam in the interior volume. After the cooking operation is complete, the platen 60 may be moved to the non-cooking position using the lift mechanism 48.

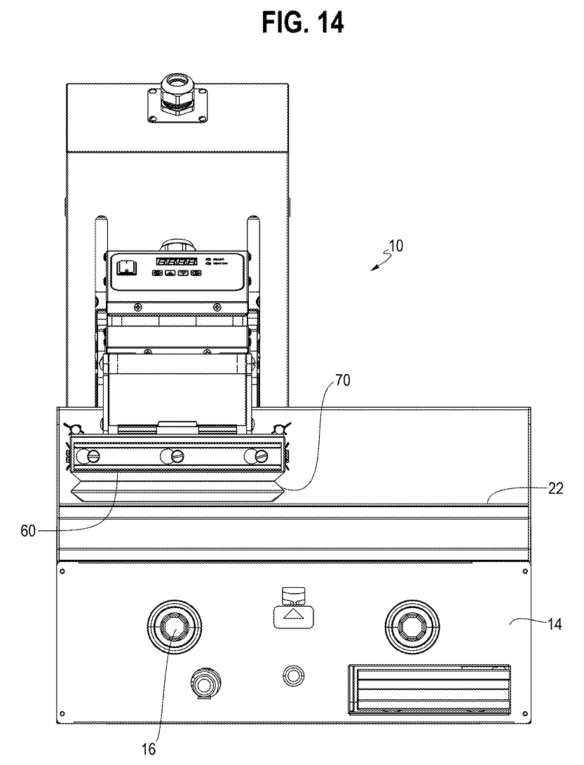

Referring to FIGS. 14-19A another embodiment of the clam shell grill 10 is shown. It will be understood that components, features, and details discussed above with respect to FIGS. 1-8 and FIGS. 9-13 may apply to the embodiments shown in FIGS. 14-19A and may not be repeated below or shown in the figures for the sake of simplicity, for example, including features related to the fluid source. New features discussed below with respect to embodiments in FIGS. 14-19A may be incorporated into or be used to replace similar components/features in the embodiments shown in FIGS. 1-13. A person of ordinary skill in the art will understand that embodiments shown in FIGS. 1-8, 9-13, and 14-19A are presented to show different features that can be selectively combined to achieve desired performance results, without undue experimentation.

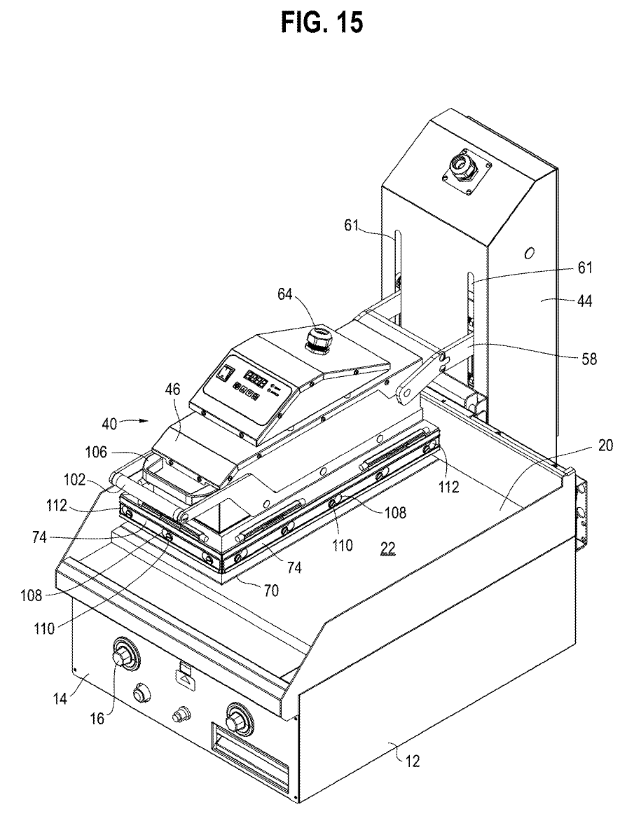

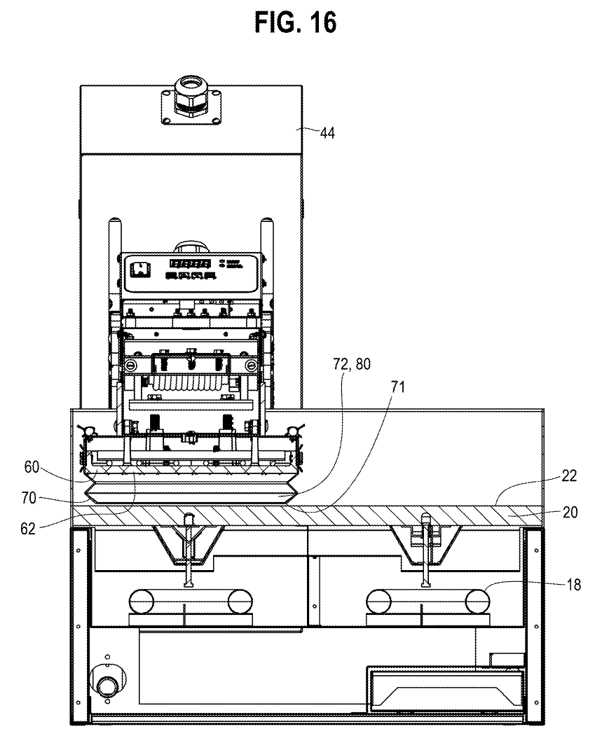

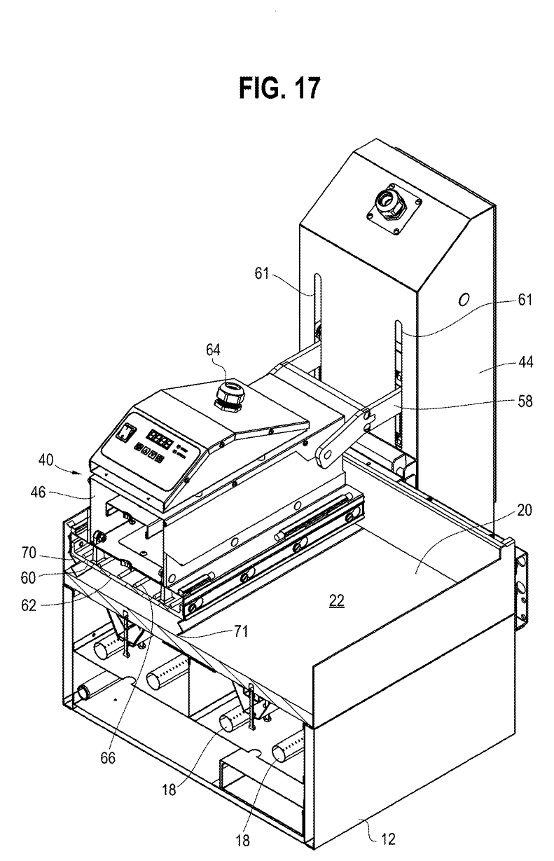

Referring to FIGS. 14-19A, the clamshell grill 10 includes a housing 12 having a front control panel 14 with a plurality of temperature setting controls 16, shown as knobs. As shown in FIGS. 16 and 17, a plurality of heating elements 18 is disposed in a base of the housing. A griddle plate 20 is supported by the housing 12 over the heating elements 18. When actuated by the control(s) 16, the heating elements 18 heat the griddle plate 20, which defines an upper cooking surface 22. A platen assembly 40 may be secured to the housing. The platen assembly includes a lift housing 44 and a platen housing 46. The platen housing 46 supports a platen 60 having a lower surface 62 facing the cooking surface 22. A lift mechanism 48 is disposed in the lift housing 44. The platen housing 46 is coupled to a carriage 54 in the lift housing 44 with a pair of arms 58, which extend through a pair of laterally spaced and longitudinally extending slots 61 formed in the front face of the lift housing 44. The carriage 54 and platen housing 46 may be manually raised and lowered, for example with the assistance of a first handle 102 coupled to the platen housing 46 (e.g., as shown in FIG. 15). In some embodiments, the first handle 102 is configured to be grasped by a user and configured to facilitate moving the platen 60 between the cooking position and the non-cooking position via the lift mechanism.

A compressible seal 70, defining a perimeter of an interior cooking cavity, is connected to the platen 60, or alternatively to the housing 46. The seal 70 may extend around the perimeter, or periphery, of the platen 60, and defines a closed ring. The closed ring may define a perimeter of an interior cooking cavity 72. The seal 70 may include a base portion 74 coupled to the platen 60, for example integrally or with adhesive and/or mechanical fasteners. In some embodiments, as shown in FIG. 15, the base portion 74 includes a plurality of keyholes 108 configured to be selectively coupled and secured to a plurality of pins 110 extending outwardly from the side surface 112 of the platen 60, respectively. In some embodiments, as shown in FIGS. 16 and 17, for example, the compressible seal 70 has a zig-zag configuration such that its different portions can be folded/move towards each other when the platen 60 continues to move towards the cooking surface 22 after the lower edge 71 of the seal 70 contacts the cooking surface 22 such that changing the size of the enclosed cooking volume 80.

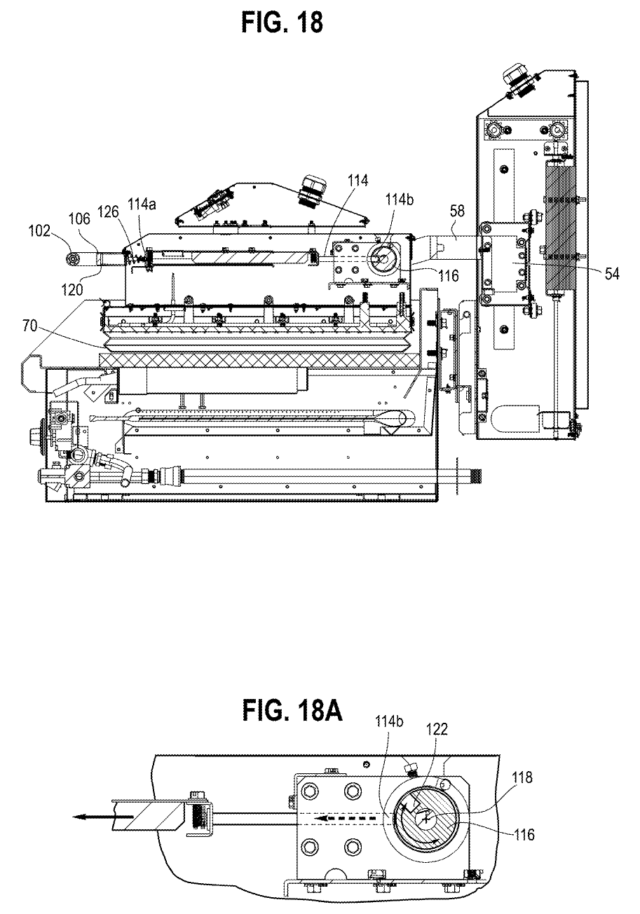

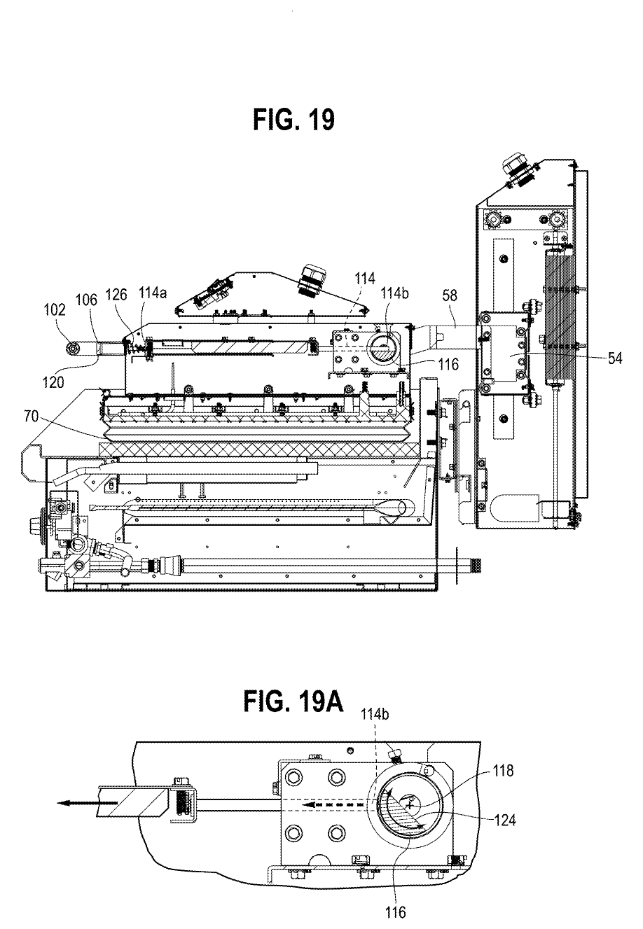

Referring to FIGS. 15 and 18-19A, in some embodiments, the clamshell grill 10 includes a release mechanism including at least a releaser 106, a release shaft 116, and a connecting shaft 114 extending between a first end 114a and a second end 114b, where the first end 114a of the connecting shaft 114 is connected to the releaser 106, and the second end 114b of the connecting shaft 114 selectively engages the release shaft 116. In some embodiments, the release shaft 116 may be disposed between the pair of arms 58 and is configured to be selectively rotatable around a main axis 118 (e.g., as shown in FIGS. 18A and 19A, extending into the page, and generally parallel to the lateral direction). Rotation of the release shaft 116 causes the platen 60 and the platen housing 46 to pivot around the main axis 118.

In some embodiments, the release mechanism is configured to be movable between a locked state (e.g., as shown in FIGS. 18 and 19 ) and a released state (e.g., as shown in FIGS. 18A and 19A), where when the release mechanism is in the locked state, the platen 60 is prevented from pivoting around the main axis 118, and when the release mechanism is in the released state, the platen is allowed to be pivoted around the main axis 118. In some embodiments, the releaser 106 is configured to be selectively movable to allow the platen 60 to be pivoted or prevent the platen 60 from being pivoted around the main axis 118.

Referring to FIGS. 18-19A, the releaser 106 is moveable between a first position 120 (e.g., as shown in FIGS. 18 and 19) and a second position (closer to the first handle 102), where when the releaser 106 is in the first position 120, the second end 114b of the connecting shaft 114 engages the release shaft 116 such that the release shaft 116 is prevented from rotating around the main axis 118, and when the releaser 106 is in the second position, the second end 114b of the connecting shaft 114 disengages the release shaft 116 such that the release shaft 116 is allowed to rotate around the main axis 118.

In some embodiments, as shown in FIGS. 18 and 18A, the release shaft 116 includes a notch 122 that is configured to receive the second end 114b of the connecting shaft 114 when the releaser 106 is in the first position, such that the release shaft 116 is prevented from rotating around the main axis 118 and the release mechanism is in the locked state. Moving the releaser 106 towards the first handle 102 and to the second position allows the second end 114b of the connecting shaft 114 moves out of the notch 122 such that the release shaft 116 is allowed to rotate around the main axis 118 and the release mechanism is in the released state.

In some embodiments, as shown in FIGS. 19 and 19A, the release shaft 116 has a generally D shape with a generally flat surface 124 that is configured to contact/engage the second end 114b of the connecting shaft 114 when the releaser 106 is in the first position, such that the release shaft 116 is prevented from rotating around the main axis 118 and the release mechanism is in the locked state. Moving the releaser 106 towards the first handle 102 and to the second position allows the second end 114b of the connecting shaft 114 moves away from and disengages the surface 124 of the release shaft 116 such that the release shaft 116 is allowed to rotate around the main axis 118 and the release mechanism is in the released state. It will be understood that the release mechanism may be configured in other ways, for example, including having the second end 114b of the connecting shaft 114 releasably engaging with a portion of the lift housing 44 and/or the pair of arms 58, without departing from the scope of the present disclosure.

In some embodiments, as shown in FIGS. 15,18, and 19, for example, a spring 126 may be disposed between the releaser 106 and the first end 114a of the connecting shaft 114, such that when the releaser 106 is moved towards the first handle 102, the spring 126 is compressed by the first end 114a of the connecting shaft 114, and when the releaser 106 is released, the spring 126 biases the first end 114a of the connecting shaft 114 away from the first handle 102, so that the release mechanism is back to the locked state.

In use, a user may pivot the platen 60 by moving the releaser 106 towards the first handle 102, or in other words, by moving the release mechanism from the locked state to the released state. The user may grab onto the first handle 102 and the releaser 106 using one hand and squeeze the releaser 106 such that it moves toward the first handle 102 and the release mechanism moves to the released state. The user may then pivot the platen 60 upwards, which provides a larger space between the platen 60 and the cooking surface 22, allowing for easy access to that space, which facilitates cleaning that area, and/or adding or removing food product in that area. Then the user may pivot the platen 60 downwards and release the releaser 106 such that the release mechanism moves back to the locked state. Although the releaser 106 is shown as a handle in FIG. 15, it should be understood that the releaser 106 may have other configurations (e.g., knob, push button), without departing from the scope of the present disclosure, as long as the releaser 106 is configured to move the release mechanism between a locked state and a released state such that the platen is selectively to be prevented from pivoting or allowed to pivot.

The subject matter of the disclosure may also relate, among others, to the following aspects:

A first aspect relates to a clamshell grill comprising: a griddle plate defining a cooking surface; a platen comprising a compressible seal defining a perimeter of an interior cooking cavity, wherein the platen is moveable between a non-cooking position, wherein the seal is spaced apart from the cooking surface, and a cooking position, wherein the seal is engaged with the cooking surface and defines an enclosed cooking volume; and a fluid source coupled to the platen and comprising an outlet in fluid communication with the enclosed cooking volume at least when the platen is moved to the cooking position.

A second aspect relates to the clamshell grill of aspect 1, wherein the compressible seal comprises a closed ring defining the perimeter of the interior cooking cavity.

A third aspect relates to the clamshell grill of any preceding aspect, wherein the seal has a compressibility of between and including 1/8 inch and 4 inches.

A fourth aspect relates to the clamshell grill of any preceding aspect, wherein the fluid source comprises a liquid and/or steam source.

A fifth aspect relates to the clamshell grill of any preceding aspect, wherein the fluid source comprises a gravity-fed fluid source.

A sixth aspect relates to the clamshell grill of any preceding aspect, wherein the fluid source is a pressurized fluid source.

A seventh aspect relates to the clamshell grill of any preceding aspect, wherein the outlet is formed in the seal.

An eighth aspect relates to the clamshell grill of any preceding aspect, wherein the platen comprises an upper plate, wherein the outlet is formed in the upper plate.

A ninth aspect relates to the clamshell grill of any preceding aspect, wherein the platen comprises a platen plate having a surface facing the cooking surface, wherein the surface of the platen plate and/or the cooking surface are heatable.

A tenth aspect relates to the clamshell grill of any preceding aspect, further comprising a housing supporting the griddle plate, and wherein the platen is coupled to the housing with a lift mechanism.

An eleventh aspect relates to the clamshell grill of any preceding aspect, wherein the lift mechanism is configured to pivot and/or translate the platen as the platen is moved between the cooking and non-cooking positions.

A twelfth aspect relates to the clamshell grill of any preceding aspect, further comprising a first handle configured to facilitate moving the platen between the cooking position and the non-cooking position via a lift mechanism.

A thirteenth aspect relates to the clamshell grill of any preceding aspect, further comprising a releaser configured to be selectively movable to allow the platen to be pivoted or prevent the platen from being pivoted.

A fourteenth aspect relates to the clamshell grill of any preceding aspect, further comprising a release mechanism configured to be movable between a locked state and a released state, wherein when the release mechanism is in the locked state, the platen is prevented from pivoting around a main axis, and when the release mechanism is in the released state, the platen is allowed to be pivoted around the main axis.

A fifteenth aspect relates to the clamshell grill of any preceding aspect, wherein the release mechanism comprises a releaser and a connecting shaft extending between a first end and a second end, wherein the first end of the connecting shaft is connected to the releaser, and the second end of the connecting shaft selectively engages a release shaft configured to be selectively rotatable around the main axis.

A sixteenth aspect relates to the clamshell grill of any preceding aspect, wherein the releaser is moveable between a first position and a second position, wherein when the releaser is in the first position, the second end of the connecting shaft engages the release shaft such that the release shaft is prevented from rotating around the main axis, and wherein when the releaser is in the second position, the second end of the connecting shaft disengages the release shaft such that the release shaft is allowed to rotate around the main axis.

A seventeenth aspect relates to a platen assembly configured for use with a griddle plate, the platen assembly comprising: a housing; a platen moveably coupled to the housing, wherein the platen is moveable between a non-cooking position and a cooking position, the platen comprising: a plate defining a cooking surface; a compressible seal extending from the cooking surface, wherein the seal defines a perimeter of an interior cooking cavity; and a fluid source coupled to the platen and comprising an outlet in fluid communication with the interior cooking cavity at least when the platen is moved to the cooking position.

An eighteenth aspect relates to the platen assembly of aspect 17, wherein the platen is moveably coupled to the housing with a lift mechanism.

A nineteenth aspect relates to the platen assembly of any one of aspects 17 or 18, wherein the compressible seal comprises a closed ring defining the perimeter of the interior cooking cavity.

A twentieth aspect relates to the platen assembly of any one of aspects 17 to 19, wherein the seal has a compressibility between and including 1/8 inch and 4 inches.

A twenty-first aspect relates to the platen assembly of any one of aspects 17 to 20, wherein the fluid source comprises a liquid and/or steam source.

A twenty-second aspect relates to the platen assembly of any one of aspects 17 to 21, wherein the fluid source comprises a gravity fed fluid source.

A twenty-third aspect relates to the platen assembly of any one of aspects 17 to 22, wherein the fluid source comprises a pressurized fluid source.

A twenty-fourth aspect relates to the platen assembly of any one of aspects 17 to 23, wherein the outlet is formed in the seal.

A twenty-fifth aspect relates to the platen assembly of any one of aspects 17 to 24, wherein the outlet is formed in the plate.

A twenty-sixth aspect relates to the platen assembly of any one of aspects 17 to 25, wherein the cooking surface is heatable.

A twenty-seventh aspect relates to a method of cooking a food product comprising: depositing the food product on a cooking surface of a griddle plate; moving a platen comprising a compressible seal defining a perimeter of an interior cooking cavity from a non-cooking position, wherein the seal is spaced apart from the cooking surface to a cooking position, wherein the seal is engaged with the cooking surface and together with the platen and the cooking surface defines an enclosed cooking volume; and introducing a fluid into the enclosed cooking volume from a fluid source coupled to the platen.

A twenty-eighth aspect relates to the method of aspect 27, wherein the compressible seal comprises a closed ring defining the interior cooking cavity.

A twenty-ninth aspect relates to the method of any one of aspects 27 or 28, wherein moving the platen to the cooking position comprises compressing the seal to between and including 1/8 inch and 4 inches.

A thirtieth aspect relates to the method of any one of aspects 27 to 29, wherein introducing the fluid comprises introducing a liquid and/or steam.

A thirty-first aspect relates to the method of any one of aspects 27 to 30, wherein introducing the fluid comprises flowing the fluid by gravity.

A thirty-second aspect relates to the method of any one of aspects 27 to 31, wherein introducing the fluid comprises introducing a pressurized fluid source.

A thirty-third aspect relates to the method of any one of aspects 27 to 32, wherein introducing the fluid comprises introducing the fluid through an outlet formed in the seal.

A thirty-fourth aspect relates to the method of any one of aspects 27 to 33, wherein introducing the fluid comprises introducing the fluid through an outlet defined in an upper plate of the platen.

A thirty-fifth aspect relates to the method of any one of aspects 27 to 34, wherein the platen comprises a plate having a surface facing the cooking surface, and further comprising heating the surface of the platen plate and/or the cooking surface.

A thirty-sixth aspect relates to the method of any one of aspects 27 to 35, wherein moving the platen comprises moving a lift mechanism coupled to a housing supporting the griddle plate.

A thirty-seventh aspect relates to the method of any one of aspects 27 to 36, wherein moving the platen comprises pivoting and/or translating the platen.

A thirty-eighth aspect relates to the method of any one of aspects 27 to 37, wherein pivoting the platen comprises moving a releaser towards a first handle.

A thirty-ninth aspect relates to the method of any one of aspects 27 to 38, wherein pivoting the platen comprises moving a release mechanism from a locked state to a released state.

A fortieth aspect relates to a clamshell grill comprising: a griddle plate defining a cooking surface; a platen moveable relative to the cooking surface from a non-cooking position to a cooking position; and a panel moveably connected to the platen, wherein the panel is engageable with the cooking surface and moveable relative to the platen as the platen is moved between the non-cooking position and the cooking position, wherein the panel defines at least in part an enclosed cooking volume when engaged with the cooking surface.

A forty-first aspect relates to the clamshell grill of aspect 40, further comprising a fluid source coupled to the platen and comprising an outlet in fluid communication with the enclosed cooking volume at least when the platen is moved to the cooking position.

A forty-second aspect relates to the clamshell grill of any one of aspects 40 or 41, wherein the panel comprises a first side panel, and further comprising a second side panel engageable with the cooking surface and moveable relative to the platen as the platen is moved between the non-cooking position and the cooking position, wherein the first and second side panels define at least in part the enclosed cooking volume.

A forty-third aspect relates to the clamshell grill of any one of aspects 40 to 42, further comprising a front panel engageable with the cooking surface and moveable relative to the platen as the platen is moved between the non-cooking position and the cooking position, wherein the front panel further defines at least in part the enclosed cooking volume.

A forty-fourth aspect relates to the clamshell grill of any one of aspects 40 to 43, wherein the first and second side panels and the front panel are integrally formed as a perimeter housing.

A forty-fifth aspect relates to the clamshell grill of any one of aspects 40 to 44, wherein one of the panel and platen comprises at least one elongated slot and the other of the panel and the platen comprises at least one shaft disposed in the slot, wherein the at least one shaft slides in the at least one slot as the panel is moved relative to the platen.

A forty-sixth aspect relates to a clamshell grill comprising: a griddle plate defining a lower cooking surface; a platen comprising an upper cooking surface; a sealing member coupled to the platen and comprising a sealing edge; wherein the platen is moveable between a non-cooking position, wherein the sealing edge is spaced apart from the cooking surface, and a cooking position, wherein the sealing edge is engaged with the cooking surface and defines an enclosed cooking volume; and wherein the sealing edge is moveable relative to the upper cooking surface as the platen is moved between the non-cooking and cooking positions.

A forty-seventh aspect relates to the clamshell grill of aspect 46, wherein the sealing member comprises a compressible seal defining the side edge.

A forty-eighth aspect relates to the clamshell grill of any one of aspects 46 or 47, further comprising a fluid source coupled to the platen and comprising an outlet in fluid communication with the enclosed cooking volume at least when the platen is moved to the cooking position.

A forty-ninth aspect relates to the clamshell grill of any one of aspects 46 to 48, wherein the sealing member comprises a panel moveably coupled to the platen and defining the side edge.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

We claim:

1. A clamshell grill comprising:
a griddle plate defining a cooking surface;
a platen comprising a compressible seal defining a perimeter of an interior cooking cavity, wherein the platen is moveable between
a non-cooking position, wherein the seal is spaced apart from the cooking surface, and
a cooking position, wherein the seal is engaged with the cooking surface and defines an enclosed cooking volume; and
a fluid source coupled to the platen and comprising an outlet in fluid communication with the enclosed cooking volume at least when the platen is moved to the cooking position.

2. The clamshell grill of claim 1, wherein the compressible seal comprises a closed ring defining the perimeter of the interior cooking cavity.

3. The clamshell grill of claim 1, wherein the platen comprises a platen plate having a surface facing the cooking surface, wherein the surface of the platen plate and/or the cooking surface are heatable.

4. The clamshell grill of claim 1, further comprising a housing supporting the griddle plate, and wherein the platen is coupled to the housing with a lift mechanism.

5. The clamshell grill of claim 4, wherein the lift mechanism is configured to pivot and/or translate the platen as the platen is moved between the cooking and non-cooking positions.

6. The clamshell grill of claim 1, further comprising a first handle configured to facilitate moving the platen between the cooking position and the non-cooking position via a lift mechanism.

7. The clamshell grill of claim 6, further comprising a releaser configured to be selectively movable to allow the platen to be pivoted or prevent the platen from being pivoted.

8. The clamshell grill of claim 1, further comprising a release mechanism configured to be movable between a locked state and a released state, wherein when the release mechanism is in the locked state, the platen is prevented from pivoting around a main axis, and when the release mechanism is in the released state, the platen is allowed to be pivoted around the main axis.

9. The clamshell grill of claim 8, wherein the release mechanism comprises a releaser and a connecting shaft extending between a first end and a second end, wherein the first end of the connecting shaft is connected to the releaser, and the second end of the connecting shaft selectively engages a release shaft configured to be selectively rotatable around the main axis.

10. The clamshell grill of claim 9, wherein the releaser is moveable between a first position and a second position, wherein when the releaser is in the first position, the second end of the connecting shaft engages the release shaft such that the release shaft is prevented from rotating around the main axis, and wherein when the releaser is in the second position, the second end of the connecting shaft disengages the release shaft such that the release shaft is allowed to rotate around the main axis.

11. A platen assembly configured for use with a griddle plate, the platen assembly comprising:
a housing;
a platen moveably coupled to the housing, wherein the platen is moveable between a non-cooking position and a cooking position, the platen comprising:
a plate defining a cooking surface;
a compressible seal extending from the cooking surface, wherein the seal defines a perimeter of an interior cooking cavity; and
a fluid source coupled to the platen and comprising an outlet in fluid communication with the interior cooking cavity at least when the platen is moved to the cooking position.

12. The platen assembly of claim 11, wherein the platen is moveably coupled to the housing with a lift mechanism.

13. The platen assembly of claim 11, wherein the compressible seal comprises a closed ring defining the perimeter of the interior cooking cavity.

14. The platen assembly of claim 11, wherein the seal has a compressibility between and including 1/8 inch and 4 inches.

15. A method of cooking a food product comprising:
depositing the food product on a cooking surface of a griddle plate;
moving a platen comprising a compressible seal defining a perimeter of an interior cooking cavity from a non-cooking position, wherein the seal is spaced apart from the cooking surface to a cooking position, wherein the seal is engaged with the cooking surface and —together with the platen and the cooking surface— defines an enclosed cooking volume; and
introducing a fluid into the enclosed cooking volume from a fluid source coupled to the platen.

16. The method of claim 15, wherein moving the platen to the cooking position comprises compressing the seal to between and including 1/8 inch and 4 inches.

17. The method of claim 15, wherein moving the platen comprises moving a lift mechanism coupled to a housing supporting the griddle plate.

18. The method of claim 15, wherein moving the platen comprises pivoting and/or translating the platen.

19. The method of claim 18, wherein pivoting the platen comprises moving a releaser towards a first handle.

20. The method of claim 18, wherein pivoting the platen comprises moving a release mechanism from a locked state to a released state.
